(19) United States
(12) Patent Application Publication
(10) Pub. No.: US 2025/0362236 A1
(43) Pub. Date: Nov. 27, 2025

(54) INSPECTION APPARATUS, METHOD OF INSPECTION USING THE INSPECTION APPARATUS, AND ELECTRONIC DEVICE MANUFACTURED USING THE INSPECTION APPARATUS

(71) Applicant: Samsung Display Co., LTD., Yongin-si (KR)

(72) Inventor: MINHO RYU, Yongin-si (KR)

(21) Appl. No.: 19/040,058

(22) Filed: Jan. 29, 2025

(30) Foreign Application Priority Data
May 21, 2024 (KR) 10-2024-0065830

(51) Int. Cl. G01N 21/88; G01N 21/17; G01N 21/93

(52) U.S. Cl. CPC G01N 21/8806; G01N 21/17; G01N 21/93; G01N 2021/1765; G01N 2021/8841; G01N 2201/11; G01N 2201/12723

(57) ABSTRACT

A inspection apparatus includes a light-emitting part that emits light, a first align key attached to one side of the light-emitting part, a light-receiving part disposed to be spaced apart from the light-emitting part in a first direction and receiving the light emitted from the light-emitting part, and a camera attached to one side of the light-receiving part, disposed to be spaced apart from the align key in the first direction, and capturing the first align key.

This application claims priority to Korean Patent Application No. 10-2024-0065830, filed on May 21, 2024, and all the benefits accruing therefrom under 35 U.S.C. § 119, the content of which in its entirety is herein incorporated by reference.

### BACKGROUND

### 1. Field

The disclosure relates to an inspection apparatus for a display device, a method of inspection using the inspection apparatus, and an electronic device manufactured using the inspection apparatus. More specifically, the disclosure relates to an inspection apparatus for the display device that provides visual information and the method of inspection using the same.

### 2. Description of the Related Art

Customers' demands for display devices are becoming more diverse, and the tendency to consume larger screen displays is increasing. Additionally, in order to increase an efficiency of the display device manufacturing process, attempts are continuing to manufacture many display devices at once using relatively large substrates. Accordingly, as a size of the substrate increases, a phenomenon of sagging occurs during manufacturing of the substrate, making it difficult to determine exact physical characteristics of the substrate at each location.

### SUMMARY

Recently, in order to inspect a transmittance of enlarged substrate, an inspection apparatus that moves the light-emitting part and the light-receiving part separately has been developed. However, problems such as movement deviation occurring due to the separate movement of the light-emitting part and the light-receiving part have been raised. Various types of research are being conducted to solve these problems.

One purpose of the disclosure is to provide an inspection apparatus for a display device with a reduced error rate.

Another purpose of the disclosure is to provide a method of inspection using the inspection apparatus.

Still another purpose of the disclosure is to provide an electronic device manufactured using the inspection apparatus.

An inspection apparatus in an embodiment of the disclosure includes a light-emitting part that emits light, a first align key attached to one side of the light-emitting part, a light-receiving part disposed to be spaced apart from the light-emitting part in a first direction and receiving the light emitted from the light-emitting part, and a camera attached to one side of the light-receiving part, disposed to be spaced apart from the align key in the first direction, and capturing the first align key.

In an embodiment, the inspection apparatus may further include a first moving part connected to the light-emitting part and the first align key and moving the light-emitting part and the first align key and a second moving part disposed to be spaced apart from the first moving part in the first direction, connected to the light-receiving part and the camera, and moving the light-receiving part and the camera.

In an embodiment, the first moving part and the second moving part may move the light-emitting part and the light-receiving part respectively in a second direction intersecting the first direction.

In an embodiment, the inspection apparatus may further include a control part that controls movement of the first moving part and the second moving part in the first direction or a second direction intersecting the first direction.

In an embodiment, the camera may check whether the first align key is centered and whether the first align key is focused based on an image captured of the first align key.

In an embodiment, the light-emitting part and the light-receiving part may overlap in a plan view.

In an embodiment, the first align key and the camera may overlap in the plan view.

In an embodiment, the light-receiving part and the light-emitting part may be spaced apart from each other by a first distance in the first direction, and the first distance may be about 99.6 millimeters (mm) to about 100.4 mm.

In an embodiment, the inspection apparatus may further include a stage accommodating a substrate between the light-emitting part and the light-receiving part.

In an embodiment, the stage may accommodate the substrate having a length of about 500 mm to 2000 mm on one side.

In an embodiment, the substrate may include a second align key, and the camera may measure an amount of sagging of the substrate by capturing an image of the second align key of the substrate.

In an embodiment, the light-emitting part and the light-receiving part may move in a second direction intersecting the first direction, and the stage may move in a third direction intersecting the first direction and the second direction.

In an embodiment, the light-emitting part and the substrate may be spaced apart by a second distance, and the second distance may be about 69.2 mm to about 70 mm.

In an embodiment, the light-receiving part and the substrate may be spaced apart by a third distance, and the third distance may be about 29.6 mm to about 30.4 mm.

An inspection apparatus in another embodiment of the disclosure includes a light-emitting part that emits light, a camera attached to one side of the light-emitting part, a light-receiving part disposed to be spaced apart from the light-emitting part in a first direction and receiving the light emitted from the light-emitting part, an align key attached to one side of the light-receiving part and spaced apart from the camera in the first direction, and a stage accommodating a substrate between the light-emitting part and the light-receiving part.

In an embodiment, the camera may check whether the align key is centered and whether the align key is focused based on an image captured of the align key.

A method of inspection in an embodiment of the disclosure includes measuring and correcting a separation distance in a first direction between a light-emitting part connected to a first moving part and a light-receiving part connected to a second moving part spaced apart from the first moving part in the first direction, and measuring and correcting a movement distance in a second direction intersecting the first direction of each of the light-emitting part and the light-receiving part, measuring an amount of deflection of a substrate disposed between the first moving part and the second moving part in a cross-sectional view using a camera attached to one side of the light-receiving part, and correcting a movement deviation of each of the first moving part and the second moving part in the second direction by an amount of sagging of the substrate.

In an embodiment, in measuring the separation distance in the first direction and the movement distance in the second direction, the camera may measure the movement distance by checking whether an align key is disposed in a center and the separation distance by checking whether the align key is focused based on an image of the align key attached to one side of the light-emitting part.

In an embodiment, the method may further include after correcting the movement deviation of each of the first moving part and the second moving part, measuring a transmittance of the substrate using the light-emitting part and the light-receiving part.

In an embodiment, in the measuring the transmittance of the substrate, light emitted from the light-emitting part may converge on the substrate.

An electronic device in an embodiment of the disclosure includes a display module and a processor configured to drive the display module, and wherein the display module is manufactured by an inspection apparatus including a light-emitting part that emits light, a first align key attached to one side of the light-emitting part, a light-receiving part which is spaced apart from the light-emitting part in a first direction and receives the light emitted from the light-emitting part, and a camera which is attached to one side of the light-receiving part, is spaced apart from the first align key in the first direction, and captures the first align key.

An inspection apparatus in an embodiment of the disclosure may include a light-emitting part that emits light, a first align key attached to one side of the light-emitting part, a light-receiving part disposed to be spaced apart from the light-emitting part in a first direction and receiving the light emitted from the light-emitting part, and a camera attached to one side of the light-receiving part, disposed to be spaced apart from the align key in the first direction, and capturing the first align key.

Accordingly, the light-emitting part may move by the first moving part and the light-receiving part may move by the second moving part independently, so that a transmittance test may be performed on substrate having a long one side. In addition, by measuring an amount of deflection of the substrate using the camera and the first align key, accurate transmittance may be measured for each position of the substrate.

### BRIEF DESCRIPTION OF THE DRAWINGS

The accompanying drawings, which are included to provide a further understanding of the inventive concept and are incorporated in and constitute a part of this specification, illustrate embodiments of the inventive concept together with the description.

FIG. 1 is a schematic view showing an embodiment of an inspection apparatus according to the disclosure.

FIG. 2 is a perspective view showing the stage of FIG. 1.

FIG. 3 is a cross-sectional view showing the light-emitting part and the light-receiving part of FIG. 1.

FIG. 4 is a perspective view showing an embodiment of a substrate included in the stage of FIG. 2.

FIGS. 5, 6, 7, 8, 9, and 10 are views for explaining a method of inspection of the inspection apparatus of FIG. 1. FIG. 10 is an enlarged view of area A of FIG. 9.

FIG. 11 is a schematic diagram showing an embodiment of an inspection apparatus according to the disclosure.

FIG. 12 is block-diagram for showing an electronic device according to an embodiment of the disclosure.

FIG. 13 is schematic views for showing the electronic device according to various embodiments of FIG. 12.

### DETAILED DESCRIPTION

Regarding embodiments of the disclosure disclosed in this text, specific structural and functional descriptions are merely illustrative for a purpose of explaining embodiments of the disclosure, and the embodiments of the disclosure may be implemented in various forms. It should not be construed as limited to the embodiments described herein.

In this disclosure, various modifications may be made, various forms may be used, and illustrative embodiments will be illustrated in the drawings and described in detail in the text. However, this is not intended to limit the disclosure to a specific form disclosed, and it will be understood that all changes, equivalents, or substitutes which fall in the spirit and technical scope of the disclosure should be included.

Terms such as first, second, etc. may be used to describe various components, but the components should not be limited by the terms. The above terms may be used for a purpose of distinguishing one component from another component. For example, a first component may be referred to as a second component, and similarly, the second component may also be also referred to as a first component without departing from the scope of the disclosure.

When a component is referred to as being “connected” to another component, it should be understood that it may be directly connected or connected to the other component, but that other components may exist in between. Other expressions that describe the relationship between components, such as “between” and “immediately between” or “neighboring” and “directly adjacent to”, should be interpreted similarly.

The terminology used herein is for the purpose of describing particular embodiments only and is not intended to be limiting of the inventive concept. As used herein, the singular forms “a,” “an” and “the” are intended to include the plural forms as well, unless the context clearly indicates otherwise. It will be further understood that the terms “include” and/or “including,” when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term “about” can mean within one or more standard deviations, or within ±30%, 20%, 10%, 5% of the stated value, for example.

Unless otherwise defined, all terms used herein, including technical or scientific terms, have the same meaning as commonly understood by a person of ordinary skill in the technical field to which the invention pertains. Terms such as those defined in commonly used dictionaries should be interpreted as having a meaning consistent with the meaning in the context of the related technology, and unless clearly defined in the application, should not be interpreted as having an ideal or excessively formal meaning.

Hereinafter, embodiments will be described in detail with reference to the accompanying drawings. The same reference numerals are used for the same components in the drawings, and redundant descriptions of the same components will be omitted.

In this specification, a plane may be defined by a first direction D1 and a second direction D2 that intersects the first direction D1. In an embodiment, the second direction D2 may be perpendicular to the first direction D1, for example. In addition, a third direction D3 may be a normal direction of the plane. That is, the third direction D3 may be perpendicular to the plane formed by the first direction D1 and the second direction D2.

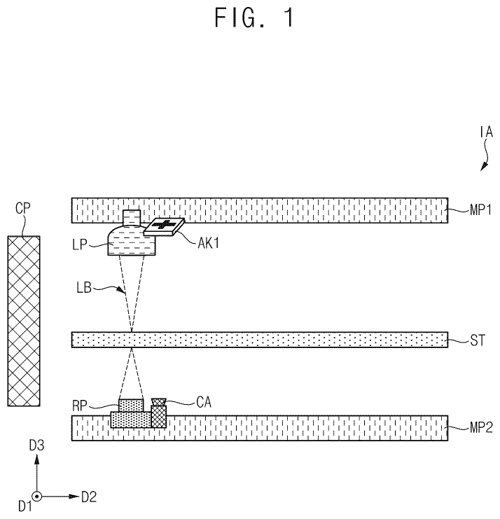

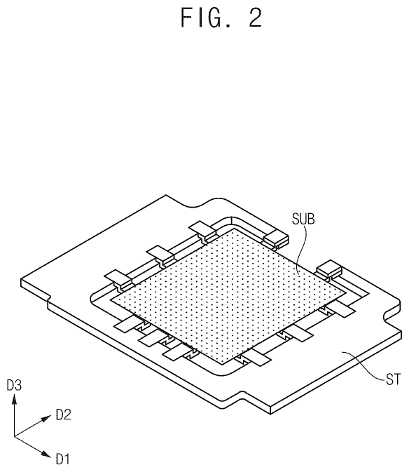

FIG. 1 is a schematic view showing an embodiment of an inspection apparatus according to the disclosure. FIG. 2 is a perspective view showing the stage of FIG. 1.

Referring to FIGS. 1 and 2, am inspection apparatus IA may include a first moving part MP1, a second moving part MP2, a stage ST, a light-emitting part LP, a light-receiving part RP, a first align key AK1, a camera CA, and a control part CP. In an embodiment, the control part CP may be a hardware component such as a circuitry, but is not limited thereto.

The first moving part MP1 and the second moving part MP2 may be spaced apart from each other in the third direction D3. The first moving part MP1 and the second moving part MP2 may move objects attached to each of the first moving part MP1 and the second moving part MP2 in the second direction D2. The control part CP may control an operation of the first moving part MP1 and the second moving part MP2.

In an embodiment, the first moving part MP1 and the second moving part MP2 may be driven separately. In an embodiment, when the light-emitting part LP is attached to the first moving part MP1 and the light-receiving part RP is attached to the second moving part MP2, the first moving part MP1 may move the light-emitting part LP in the second direction D2 separately from a movement of the second moving part MP2, for example. Likewise, the second moving part may move the light-receiving part RP in the second direction D2 separately from a movement of the first moving part MP1. That is, the first moving part MP1 and the second moving part MP2 may be independently driven by the control part CP.

The stage ST may be disposed between the first moving part MP1 and the second moving part MP2 in a cross-sectional view. The stage ST may accommodate a substrate SUB.

In an embodiment, the stage ST may move in the first direction D1. That is, the stage ST may move in the first direction D1 and in a direction opposite to the first direction D1. As the light-emitting part LP and the light-receiving part RP move in the second direction D2, and the stage ST moves in the first direction D1 and/or in a direction opposite to the first direction D1, transmittance of an entirety of the area of the substrate SUB accommodated in the stage ST may be inspected.

The light-emitting part LP may be attached to one side of the first moving part MP1. In an embodiment, the light-emitting part LP may be attached in a direction opposite to the third direction D3 of the first moving part MP1, for example. The light-emitting part LP may move in the second direction D2 by the first moving part MP1.

The light-emitting part LP may emit light LB in a direction opposite to the third direction D3. The inspection apparatus IA may inspect a transmittance of the substrate SUB accommodated in the stage ST through the light LB emitted from the light-emitting part LP. The light LB may converge at the substrate SUB and may be transmitted through the substrate SUB to diverge.

In an embodiment, a wavelength of the light LB emitted from the light-emitting part LP may be about 400 nm or more and about 780 nm or less, for example. Preferably, a wavelength of the light LB may be about 450 nm or more and about 700 nm or less. However, the disclosure is not necessarily limited thereto. When a wavelength of the light LB satisfies a range described above, the light LB may pass through the substrate SUB and transmittance may be measured.

The light-receiving part RP may be spaced apart from the light-emitting part LP in a direction opposite to the third direction D3. The light-receiving part RP may be attached to one side of the second moving part MP2. In an embodiment, the light-receiving part RP may be attached to the second moving part MP2 in the third direction D3, for example. The light-receiving part RP may move in the second direction D2 by the second moving part MP2.

The light-receiving part RP may receive the light LB emitted from the light-emitting part LP. That is, the light-receiving part RP may receive the light LB that has transmitted through the substrate SUB. The inspection apparatus IA may calculate a transmittance of the substrate SUB by analyzing the light LB received by the light-receiving part RP.

In an embodiment, the light-emitting part LP and the light-receiving part RP may overlap in a plan view. That is, in order for the light LB emitted from the light-emitting part LP to be received by the light-receiving part RP, the light-emitting part LP and the light-receiving part RP may overlap in a plan view. The control part CP may control each of the first moving part MP1 and the second moving part MP2 so that the light-emitting part LP and the light-receiving part RP overlap in a plan view.

The first align key AK1 may be attached to one side of the light-emitting part LP. The first align key AK1 may be configured as a reference for checking relative positions of the light-emitting part LP and the light-receiving part RP. As shown in FIG. 1, the first align key AK1 may have a cross shape at a center. However, the disclosure is not necessarily limited thereto.

The camera CA may be attached to one side of the light-receiving part RP. The camera CA may be spaced apart from the first align key AK1 in a direction opposite to the third direction D3. The camera CA may measure relative positions of the light-emitting part LP and the light-receiving part RP by capturing an image of the first align key AK1.

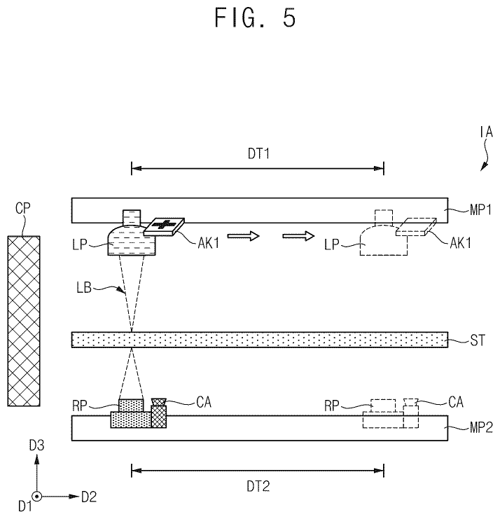

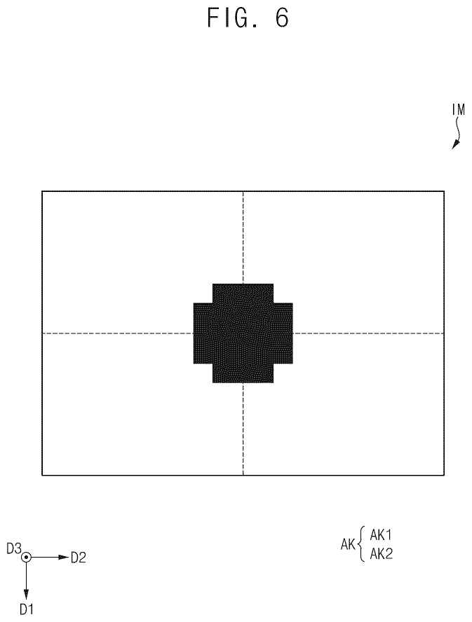

In an embodiment, the first align key AK1 and the camera CA may overlap in a plan view. The camera CA may determine whether the first align key AK1 is disposed at a center of the image (e.g., the image IM of FIG. 6) and/or whether the first align key AK1 is focused on the image (e.g., the image IM of FIG. 6) based on the image (e.g., the image IM of FIG. 6). The control part CP may control the first moving part MP1 and the second moving part MP2 based on the image (e.g., the image IM in FIG. 6). A method by which the camera CA captures the first align key AK1 will be described later with reference to FIGS. 5, 6, 7, and 8.

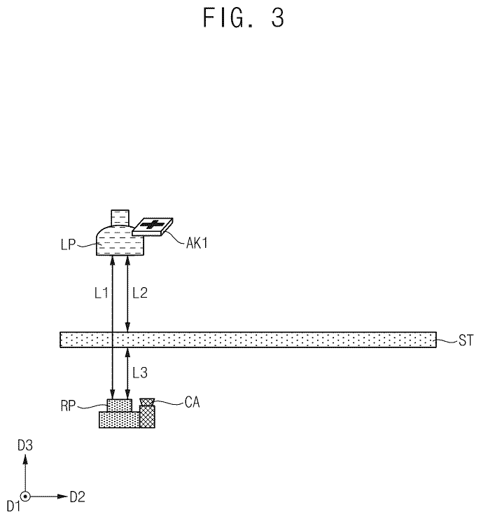

FIG. 3 is a cross-sectional view showing the light-emitting part and the light-receiving part of FIG. 1.

Referring to FIGS. 1, 2, and 3, the light-emitting part LP and the light-receiving part RP may be spaced apart from each other by a first distance (also referred to as a separation distance) L1 in the third direction D3. The control part CP may control a movement of each of the first moving part MP1 and the second moving part MP2 in the third direction D3 so that the light-emitting part LP and the light-receiving part RP to be spaced apart by the first distance L1.

In an embodiment, the first distance L1 may be about 99.6 millimeters (mm) or more and about 100.4 mm or less. Preferably, the first distance L1 may be about 99.8 mm or more and about 100.2 mm or less, for example. When the first distance L1 satisfies a range described above, the light LB emitted from the light-emitting part LP may reach the light-receiving part RP, and a transmittance of the substrate SUB may be accurately measured.

In an embodiment, the light-emitting part LP and the substrate SUB may be spaced apart by a second distance L2 in the third direction D3. In an embodiment, the second distance L2 may be about 69.2 mm or more and about 70 mm or less, for example. Preferably, the second distance L2 may be about 69.4 mm or more and about 69.8 mm or less. The light LB emitted from the light-emitting part LP may move by the second distance L2 and converge in one area of the substrate SUB.

In an embodiment, the light-receiving part RP and the substrate SUB may be spaced apart by a third distance L3 in the third direction D3. In an embodiment, the third distance L3 may be about 29.6 mm or more and about 30.4 mm or less, for example. Preferably, the third distance L3 may be about 29.8 mm or more and about 30.2 mm or less. The light LB emitted from the light-emitting part LP and transmitted through the substrate SUB may diverge and may move the third distance L3 to be received by the light-receiving part RP.

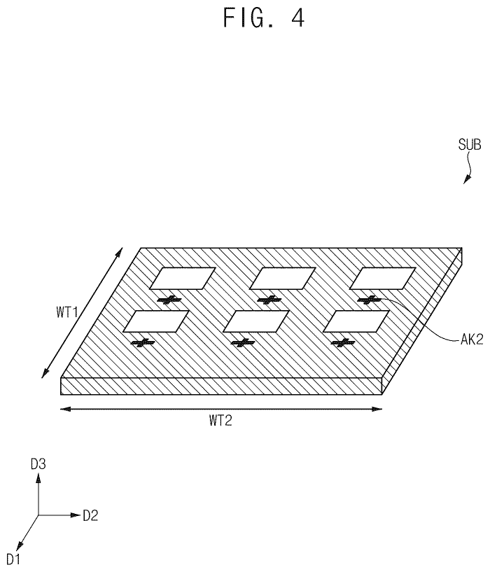

FIG. 4 is a perspective view showing an embodiment of a substrate included in the stage of FIG. 2.

Referring to FIGS. 2, 3, and 4, the substrate SUB may include a glass substrate, a metal substrate, a plastic substrate, etc. However, the disclosure is not necessarily limited thereto. The substrate SUB may be an inorganic layer, an organic layer, or a composite material layer.

In an embodiment, the substrate SUB may include a second align key AK2. As shown in FIG. 4, at least one second align key AK2 may be disposed on the substrate SUB. The second align key AK2 may be disposed in a form of a mattress in the first direction D1 and/or the second direction D2. The second align key AK2 may be used as a reference when cutting the substrate SUB.

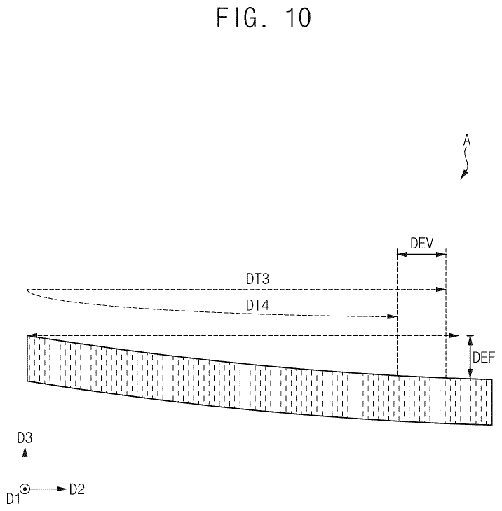

In an embodiment, the camera CA may capture an image of the second align key AK2 to calculate an amount of deflection of the substrate SUB. The camera CA may capture an image of the second align key AK2 and check whether the second align key AK2 is focused. When the second align key AK2 and the camera CA are spaced apart by the third distance L3, the second align key AK2 may be focused. When the second align key AK2 is not focused, the control part CP may align the first moving part MP1 and/or the second moving part MP2 in the third direction D3 until the second align key AK2 is focused. Through this, an amount of deflection of the substrate SUB (e.g., the amount of deflection DEF in FIG. 10) may be calculated.

In an embodiment, the substrate SUB may have a first length WT1 in the first direction D1 and a second length WT2 in the second direction D2. Each of the first length WT1 and the second length WT2 may be about 500 mm or more and about 2000 mm or less. Preferably, each of the first length WT1 and the second length WT2 may be about 1000 mm or more and about 2000 mm or less. However, the disclosure is not necessarily limited thereto.

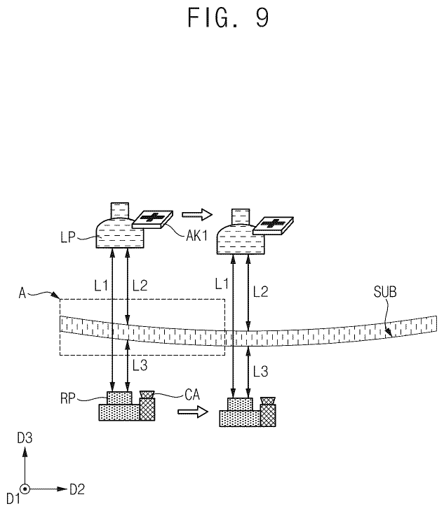

FIGS. 5, 6, 7, 8, 9, and 10 are views for explaining a method of inspection of the inspection apparatus of FIG. 1. Specifically, FIGS. 6, 7, and 8 are views showing the image IM captured by the first align key AK1 and/or the second align key AK2 using the camera CA. FIG. 10 is an enlarged view of area A of FIG. 9.

Referring to FIGS. 5, 6, 7, and 8, the first align key AK1 may be captured using the camera CA. Based on the image IM captured of the first align key AK1, the camera CA may check whether the first align key AK1 is disposed at a center of the image IM and whether the first align key AK1 is focused.

In an embodiment, the first align key AK1 may be captured using the camera CA before the light-emitting part LP and the light-receiving part RP move in the second direction D2. At this time, since the first align key AK1 and the camera CA overlap in a plan view, the captured image IM, as shown in FIG. 6, may have a cross shape of the first align key AK1 disposed in a center of the image IM and focused.

Thereafter, the first moving part MP1 may move the light-emitting part LP and the first align key AK1 by a first movement distance DT1 in the second direction D2, and the second moving part MP2 may move the light-receiving part RP and the camera CA by a second movement distance DT2 in the second direction D2. The first movement distance DT1 and the second movement distance DT2 may be substantially a same movement distance. However, due to mechanical errors, positional deviation may occur in the first movement distance DT1 and the second movement distance DT2 due to movement.

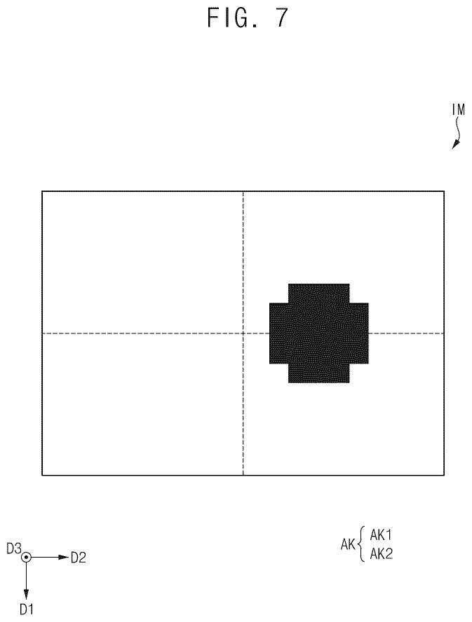

When the position deviation occurs between the first movement distance DT1 and the second movement distance DT2, as the camera CA captures the first align key AK1, the cross shape of the captured image IM may be disposed away from a center of the image IM as shown in FIG. 7. In this case, a movement of the first moving part MP1 and/or the second moving part MP2 in the second direction D2 may be controlled through the control part CP, so that a cross shape of the first align key AK1 to move at a center of the captured image IM.

In another embodiment, the first align key AK1 may be captured using the camera CA before the light-emitting part LP and the light-receiving part RP move in the second direction D2. At this time, the image IM of the first align key AK1 captured through the camera CA may be focused as shown in FIG. 6. In order for the image IM of the first align key AK1 to be focused, the first distance (e.g., the first distance L1 in FIG. 3) may be about 100 mm.

Thereafter, the first moving part MP1 may move the light-emitting part LP and the first align key AK1 by a first movement distance DT1 in the second direction D2, and the second moving part MP1 may move the light-receiving part RP and the camera CA by a second movement distance DT2 in the second direction D2. As the light-emitting part LP and the light-receiving part RP move in the second direction D2, the first distance (e.g., the first distance L1 in FIG. 3), which is a distance between the light-emitting part LP and the light-receiving part RP may have a separation deviation due to mechanical error.

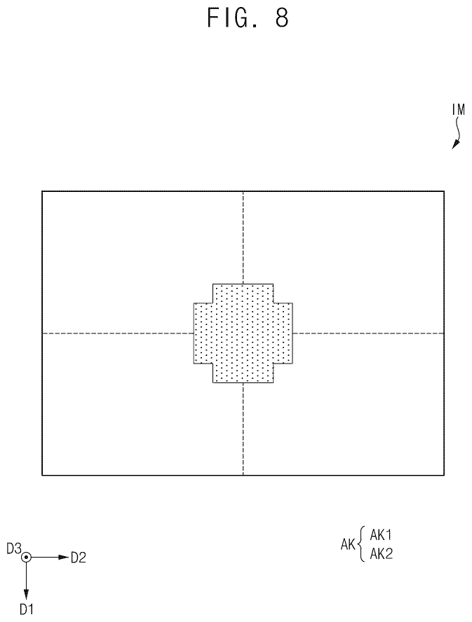

When the separation deviation occurs between the first moving part MP1 and the second moving part MP2, as shown in FIG. 8, a cross shape of the first align key AK1 may not be focused in the image IM that capture the first align key AK1. Accordingly, the control part CP may control a movement of the first moving part MP1 and/or the second moving part MP2 in the third direction D3, so that a cross shape of the first align key AK1 to be focused in the image IM, as shown in FIG. 6.

As a result, as the first moving part MP1 moves the light-emitting part LP and the first align key AK1 in the second direction D2, and the second moving part MP2 moves the light-emitting part LP and the first align key AK1 in the second direction D2, the positional deviation between the light-emitting part LP and the light-receiving part RP in the second direction D2 and the separation deviation in the third direction D3 may occur. The position deviation and the separation deviation may be corrected by the control part CP. As a result, the deviations that may occur as the first moving part MP1 and the second moving part MP2 are individually driven may be prevented or reduced by being corrected by the control part CP.

Referring to FIGS. 4, 5, 6, 7, 8, and 9, after correcting the positional deviation in the second direction D2 and separation deviation in the third direction D3 of the first moving part MP1 and the second moving part MP2, the inspection apparatus IA may measure an amount of deflection (e.g., amount of deflection DEF in FIG. 10) of the substrate SUB by the camera CA.

In an embodiment, before the light-emitting part LP and the light-receiving part RP move in the second direction D2, the camera CA may capture one of the second align key AK2 disposed in the substrate SUB. when the light-receiving part RP and the second align key AK2 of the substrate SUB are spaced apart by the third distance L3, the image IM of the second align key AK2 captured may be focused as shown in FIG. 6. In an embodiment, the third distance L3 may be about 30 mm, for example. In the description, as the image IM may be an image of the first align key AK1 or an image of the second align key AK2, may be collectively referred as an align key AK.

However, after the camera CA moves in the second direction D2 and captures the second align key AK2, the image IM of the second align key AK2 may not be focused due to sagging of the substrate SUB as shown in FIG. 8. In this case, the control part CP may move the second moving part MP2 in the third direction D3 so that the image IM of the second align key AK2 captured by the camera CA to be focused. That is, as the camera CA and the second align key AK2 are spaced apart by the third distance L3 in the third direction D3, so that sagging amount of the substrate (e.g., the sagging amount DEF in FIG. 10) may be measured.

Referring further to FIGS. 9 and 10, after measuring the deflection amount DEF of the substrate SUB, as the light-emitting part LP and the light-receiving part RP move in the second direction D2, the substrate SUB transmittance may be measured. However, as the substrate SUB may sag in a direction opposite to the third direction D3, movement deviation DEV may result in the second direction D2.

In an embodiment, a third movement distance DT3 moved in the second direction D2 may be substantially same to a fourth movement distance DT4 moved along the sagging curve of the substrate SUB. Even though the third movement distance DT3, which is a straight line distance, and the fourth movement distance DT4, which is a curved distance, are substantially same, the movement deviation DEV in the second direction D2 due to sagging of the substrate SUB may occur, for example. When the movement deviation DEV occurs, a transmittance of the substrate SUB may be measured at a location different from the preset location. In other words, a transmittance of the substrate SUB may be measured in different location as the moving deviation DEV occurs.

In order to offset this movement deviation DEV, after a deflection amount DEF of the substrate SUB is measured, then the movement deviation DEV of the substrate SUB may be measured and corrected when measuring a transmittance. Through this, accurate transmittance may be measured for each position on the substrate SUB.

As a result, as the light-emitting part LP moves by the first moving part MP1 and the light-receiving part RP moves by the second moving part MP2 independently, thereby transmittance testing may be performed against a substrate that has long side. In addition, by measuring the deflection amount DEF of the substrate through the camera CA and the second align key AK2, accurate transmittance may be measured for each position of the substrate.

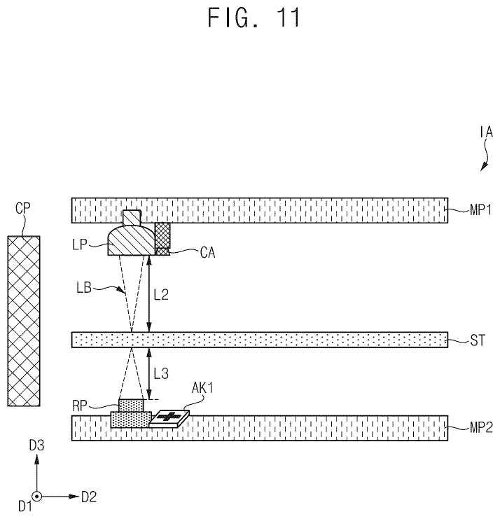

FIG. 11 is a schematic diagram showing another embodiment of an inspection apparatus according to the disclosure. The inspection apparatus IA described in FIG. 11 may differ from the inspection apparatus IA described in FIG. 1 only in an arrangement of the camera CA and the first align key AK1, and other configurations may be substantially same. Therefore, overlapping descriptions may be omitted or simplified.

Referring to FIG. 11, the light-emitting part LP may be attached to the first moving part MP1. The light-emitting part LP may be attached to the first moving part MP1 in a direction opposite to the third direction D3. The camera CA may be attached to one side of the light-emitting part LP. The camera CA may capture an image of the first align key AK1 disposed to be spaced apart in the third direction D3. That is, the camera CA may overlap the first align key AK1 in a plan view.

The light-receiving part RP may be attached to the second moving part MP2. The light-receiving part RP may be attached to the second moving part MP2 in the third direction D3. The first align key AK1 may be attached to one side of the light-receiving part RP. The first align key AK1 may be a configuration for measuring relative positions of the light-emitting part LP and the light-receiving part RP.

The disclosure may be applied to a display device and the electronic device including a same. In an embodiment, the disclosure may be applied to high-resolution smartphones, mobile phones, smart pads, smart watches, tablet personal computer (PCs), vehicle navigation systems, televisions, computer monitors, laptops, etc., for example.

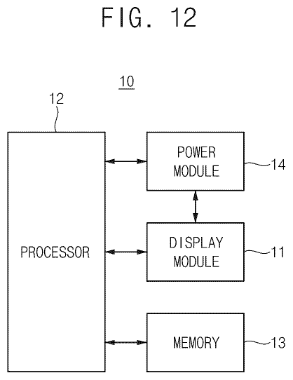

FIG. 12 is block-diagram for showing an electronic device according to an embodiment of the disclosure.

Referring to FIG. 12, the display device according to the embodiments of present disclosure may be applied to various electronic devices 10. The electronic device 10 according to an embodiment may include the display device, and may further include a module or device including additional functions in addition to the display device.

The electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data information necessary for an operation of the processor 12 or the display module 11. When the processor 12 executes an application stored in the memory 13, an image data signal and/or an input control signal may be transmitted to the display module 11, and the display module 11 may process the received signal and output image information through a display screen.

The power module 14 may include a power supply module such as a power adapter or a battery device, and a power conversion module that converts a power supplied by the power supply module to generate power necessary for an operation of the electronic device 10.

In addition, some of individual modules functionally included in one module may be included in the display device, and other parts may be provided separately from the display device. For example, the display device may include the display module 11, and the processor 12, the memory 13, and the power module 14 may be provided in the form of other devices within the electronic device 10 other than the display device.

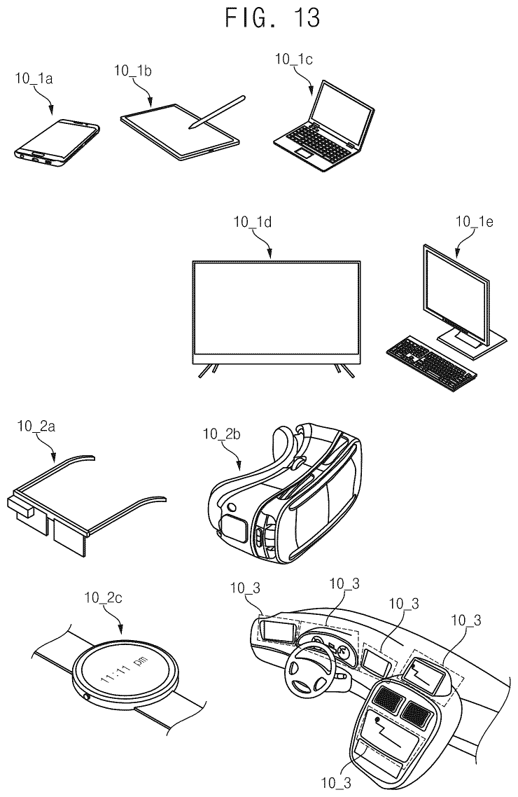

FIG. 13 is schematic views for showing the electronic device according to various embodiments of FIG. 12.

Referring to FIGS. 12 and 13, various electronic devices to which the display device according to embodiments is applied may include not only image display electronic devices such as a smart phone 10_1a, a tablet PC 10_1b, a laptop 10_1c, a TV 10_1d, and a desk monitor 10_1e, but also wearable electronic devices including display modules such as smart glasses 10_2a, a head-mounted display 10_2b, and a smart watch 10_2c, and vehicle electronic devices 10_3 including display modules such as a CID (center information display) and a room mirror display placed on a dashboard, center fascia, or dashboard of an automobile.

However, this is exemplary, and the electronic device 10 according to embodiments of the present disclosure is not limited thereto. For example, the electronic device 10 may be implemented as a mobile phone, a video phone, a smart pad, a smart watch, a tablet PC, a vehicle display, a computer monitor, a notebook computer, a head-mounted display device, etc. In addition, the electronic device 10 may be a television, a monitor, a notebook computer, or a tablet. In addition, the electronic device 10 may be an automobile.

While the disclosure has been particularly shown and described with reference to embodiments thereof, it will be understood by those of ordinary skill in the art that various changes in form and details may be made therein without departing from the spirit or scope of the disclosure as defined by the following claims.

What is claimed is:

1. An inspection apparatus comprising:
a light-emitting part that emits light;
a first align key attached to one side of the light-emitting part;
a light-receiving part which is spaced apart from the light-emitting part in a first direction and receives the light emitted from the light-emitting part; and
a camera which is attached to one side of the light-receiving part, is spaced apart from the first align key in the first direction, and captures the first align key.

2. The inspection apparatus of claim 1, further comprising:
a first moving part which is connected to the light-emitting part and the first align key and moves the light-emitting part and the first align key; and
a second moving part which is spaced apart from the first moving part in the first direction, is connected to the light-receiving part and the camera, and moves the light-receiving part and the camera.

3. The inspection apparatus of claim 2, wherein the first moving part and the second moving part moves the light-emitting part and the light-receiving part respectively in a second direction intersecting the first direction.

4. The inspection apparatus of claim 2, further comprising:
a control part that controls movement of the first moving part and the second moving part in the first direction or a second direction intersecting the first direction.

5. The inspection apparatus of claim 1, wherein the camera checks whether the first align key is centered and whether the first align key is focused based on an image captured of the first align key.

6. The inspection apparatus of claim 1, wherein the light-emitting part and the light-receiving part overlap in a plan view.

7. The inspection apparatus of claim 6, wherein the first align key and the camera overlap in the plan view.

8. The inspection apparatus of claim 1, wherein the light-receiving part and the light-emitting part are spaced apart from each other by a first distance in the first direction, and
wherein the first distance is about 99.6 millimeters to about 100.4 millimeters.

9. The inspection apparatus of claim 1, further comprising:
a stage accommodating a substrate between the light-emitting part and the light-receiving part.

10. The inspection apparatus of claim 9, wherein the stage accommodates the substrate having a length of about 500 millimeters to 2000 millimeters on one side.

11. The inspection apparatus of claim 9, wherein the substrate includes a second align key, and
wherein the camera measures an amount of sagging of the substrate by capturing an image of the second align key of the substrate.

12. The inspection apparatus of claim 9, wherein the light-emitting part and the light-receiving part move in a second direction intersecting the first direction, and
the stage moves in a third direction intersecting the first direction and the second direction.

13. The inspection apparatus of claim 9, wherein the light-emitting part and the substrate are spaced apart by a second distance, and
wherein the second distance is about 69.2 millimeters to about 70 millimeters.

14. The inspection apparatus of claim 9, wherein the light-receiving part and the substrate are spaced apart by a third distance, and
wherein the third distance is about 29.6 millimeters to about 30.4 millimeters.

15. An inspection apparatus comprising:
a light-emitting part that emits light;
a camera attached to one side of the light-emitting part;
a light-receiving part which is spaced apart from the light-emitting part in a first direction and receives the light emitted from the light-emitting part;
an align key attached to one side of the light-receiving part and spaced apart from the camera in the first direction; and
a stage accommodating a substrate between the light-emitting part and the light-receiving part.

16. The inspection apparatus of claim 15, wherein the camera checks whether the align key is centered and whether the align key is focused based on an image captured of the align key.

17. An electronic device comprising:
a display module; and
a processor configured to drive the display module, and
wherein the display module is manufactured by an inspection apparatus including:
a light-emitting part that emits light;
a first align key attached to one side of the light-emitting part;
a light-receiving part which is spaced apart from the light-emitting part in a first direction and receives the light emitted from the light-emitting part; and
a camera which is attached to one side of the light-receiving part, is spaced apart from the first align key in the first direction, and captures the first align key.
